(19) United States
(12) Patent Application Publication
(10) Pub. No.: US 2012/0022901 A1
(43) Pub. Date: Jan. 26, 2012

(54) Preference Seating System

(75) Inventors: Mark Youssef Nasr, Chicago, IL (US); Christopher Uchechuckwuka Agboola Amenechi, Houston, TX (US)

(73) Assignee: CONTINENTAL AIRLINES, INC., Houston, TX (US)

(21) Appl. No.: 13/187,337

(22) Filed: Jul. 20, 2011

Related U.S. Application Data
(60) Provisional application No. 61/366,037, filed on Jul. 20, 2010.

(51) Int. Cl. G06Q 10/00

(52) U.S. Cl. 705/5

(57) ABSTRACT

Improved techniques and systems for assigning resources in a service industry are described herein. These techniques and systems replace the first-come-first-served model traditionally used in airline seating, restaurant table placement, entertainment venue ticketing, hotel room location, and other industries with a two-part system incorporating virtual tracking of available resources and a rules-based assignment system for allocating the available resources amongst the customers. Such a system allows optimization of the resource allocation from a customer perspective (who can select resources based on personal preferences) and from a service provider perspective (who can monetize certain resources and/or allocate the resources to best meet other business goals, such as loyalty preservation, operational requirements, efficiency, etc.).

### CROSS-REFERENCE TO RELATED APPLICATIONS

The present application claims priority to U.S. Provisional Application Ser. No. 61/366,037 filed on Jul. 20, 2010, the contents of which are incorporated herein by reference.

### BACKGROUND

In many customer-service industries, customer location can be a primary determinant of customer satisfaction. For example, movie, restaurant, and hotel patrons, as well as common carrier passengers, typically have various preferences for the location of their seat, table, room, etc. Many of these industries have historically operated on a “first-come-first-served” model, in which the first customer to make a reservation and/or arrive is given their choice of location. However, this model is flawed in that it can lead to sub-optimal location selections for a number of reasons.

One reason for sub-optimal location selection is that earlier-arriving customers are prone to make “incorrect” choices based on incomplete data. For example, a restaurant patron may choose a table in a less-crowded area of a restaurant, even though it is nearer the kitchen, because he prefers a quieter setting. Such a patron may believe that the noise from the kitchen will be less than the crowd noise in a more crowded section of the restaurant. However, the patron may not know that a large party will be arriving that will have to be seated near them because there is no room for such a large party elsewhere in the restaurant. The combined noise of the large party and the kitchen can thus be more than what the patron would have experienced had he selected a table in what was a more “crowded” area of the restaurant upon arrival.

A similar problem can exist in common carrier industries, such as airlines. It is not uncommon for a passenger making an online airline reservation to be presented with a seat map showing available seats and allowing the passenger to choose a seat for himself. A customer making an early reservation may choose a seat located farther from the front of the aircraft because he perceives that the adjacent seats are not filled. However, this customer may not realize that the flight for which he is making a reservation is virtually always full, and thus the chances of him having an adjacent empty seat at the time of departure are very low. This customer would have been better off selecting a preferred seat (e.g., window or aisle) located nearer the front of the aircraft.

This selection error can also cause problems for other passengers. For example, suppose that a group of passengers (e.g., a family with small children) is travelling together. If prior passengers have selected seats based on the mistaken impression that an empty seat would be available next to them, they may be artificially spread throughout the aircraft, which does not leave a contiguous block of seats for the family. This results in a sub-optimal experience not just for the passenger seeking an adjacent empty seat, but also for the family who will be separated for their journey.

“First-come-first-served” models can also be sub-optimal from the perspective of the service provider. For example, certain customers may be willing to pay extra for their preferred seat, but this option is not available if customers without such preferences, or who are unwilling to pay extra for such preferences, have already selected all of such available seats. For example, in the airline context, a business traveler may be willing to pay an extra charge for a seat that includes a power port for his laptop computer. If, however, a traveler who does not need such a power port has selected such a seat based on its position within the aircraft or some other factor, a revenue opportunity has been lost to the carrier, in addition to the utility of the power port seat to the business traveller.

Another problem with “first-come-first-served” models from the carrier perspective that certainly exists in the airline context and may also exist in other contexts (cruise lines, trains, etc.) is the fact that early purchasers typically result in lower revenue to the carrier, while later (e.g., last minute) purchasers are typically higher revenue. However, the “first-come-first-served” model for allocating seats effectively gives the lower-revenue travelers priority for service at the expense of higher-revenue travelers. This creates an undesirable customer service situation for both the high yield customers and the airline.

Therefore, what is needed in the art is a way of allocating seats, tables, rooms, or other resources in a service-oriented industry that overcomes one or more of the shortcomings addressed above.

### SUMMARY

Disclosed herein are systems and methods for allocating semi-fungible resources in a customer-service oriented industry. One example relates to assignment of seats in the airline context, but various other applications are also available, many of which are described herein. The disclosed systems and methods can comprise two parts. The first part can be an inventory tracking system that relies upon a virtualized allocation of the resources in which the number of resources having a particular characteristic are tracked without allocating a specific resource to a specific customer. For example, an airline booking system might track the number of window seats, the number of aisle seats, the number of seats at the front of the aircraft, the number of seats at the rear of the aircraft, the number of seats with certain in-flight amenities such as power ports for portable electronics or enhanced entertainment terminals, etc. By virtualizing the allocation, customers may be offered preferences or even guarantees of a certain amenity without committing a specific resource that otherwise reduces the flexibility available to the service provider.

A second part of the systems and methods for semi-fungible resource allocation can include rules-based assignment algorithms that, at some time prior to the time the service is actually provided, takes the virtualized allocation and the aggregation of expressed consumer preferences and guarantees and assigns specific resources to each customer. In the airline context, this might include the assignment of seats to customers based upon their stated preferences or guaranteed amenities, as well as other rules, such as operational requirements, frequent flyer status, fare paid, etc. Additionally, the assignment may be based on customer data obtained in previous interactions with the customer, such as prior assigned seats, expressed preferences, etc. This second part may also include communicating the assigned resource to the customer and, in some instances, affording the customer the opportunity to change the allocated resource. For example, a passenger who has not been assigned a preferred aisle seat because of his rankings within the rules framework may nonetheless be afforded the opportunity to purchase such a seat for an additional charge.

Such systems and methods enhance the customer service experience for both the customer and the service provider. The customer's experience is enhanced because he is able to make a decision based on more complete and more reliable information about the available services and amenities. Similarly, the service provider is afforded greater flexibility in the allocation of particular resources and is also afforded the opportunity to monetize certain resources based on the demand for those certain resources and/or to provide those resources in a way that facilitates greater loyalty and improved customer satisfaction in the aggregate.

These and other aspects of the disclosed methods and systems will be more apparent in view of the following description. The foregoing summary is not intended to summarize each potential embodiment or every aspect of the present disclosure.

### BRIEF DESCRIPTION OF THE DRAWINGS

FIGS. 1A-1B depict certain user interface aspects of a system as shown and described herein.

FIGS. 2A-2B depict certain user interface aspects of a system as shown and described herein.

FIGS. 3A-3B are block diagrams of a computer system for implementing the seat selection techniques described herein.

### DETAILED DESCRIPTION

The foregoing description describes techniques, methods, and apparatuses for allocating semi-fungible resources in a service oriented industry that improve upon the “first-come-first-served” model described below. As used herein, “semi-fungible resources” refers to any aspect of the customer service experience that may in some respects be considered equal but may also be considered different for some purposes. In the airline or entertainment venue context this may be seat assignments, in the hotel or restaurant context this may be room or table location, in other industries any of a variety of other characterizations may be used. Although the following description focuses on the allocation of seats in the airline industry, the teachings herein are equally applicable to a variety of industries in which semi-fungible resources must be allocated to customers. It is not intended that the concepts described herein be limited to any particular application or industry.

An improved system for allocating semi-fungible resources can be implemented in two parts. A first part relates to the tracking of available inventory and presenting options to the customer regarding that inventory. For example, in the airline context, such inventory might include such concepts as a number of window seats or aisle seats. The inventory could also track the number of available blocks of 2, 3, or 4 seats, etc., so that passengers could determine whether the flight could accommodate their group in a preferred seating arrangement. Similarly, inventory could be tracked by position on the aircraft, e.g., front, middle, rear, etc. Availability of amenities, such as in-flight entertainment, auxiliary power ports, extra leg room, empty adjacent seats, adjacent food/drink stations, adjacent entrance/exit points, etc. may also be tracked. Additionally, pseudo-artificial “zones” can be created, such as a business zone intended for travelling business passengers or a family zone intended for families travelling together. Other zones can be created based on amenities associated with a certain portion of the aircraft, such as enhanced leg room, proximity to a lavatory or food and beverage station, etc. Other factors may be used, limited only by the ability to characterize the semi-fungible resources. By keeping track of available inventory throughout the booking process, the options presented to a customer making a reservation and/or the pricing of those options may be kept up-to-date, allowing customers to make informed decisions and allowing the service provider to price such options in accordance with market demand.

A second part of such a system includes a mechanism for assigning customers to a particular resource based upon the aggregate stated preferences of all customers. For example, in the airline context, just before check-in time for the flight, the system could assign passengers to a seat based upon the aggregate stated preferences (e.g., window/aisle seat, front/rear of aircraft, blocks of contiguous seats) and other commercial considerations (e.g., higher priority given to frequent fliers, passengers paying higher fares, regulatory or operational requirements, etc.). These and a variety of other considerations are described in greater detail below. An optional portion of such an algorithm can include notifying the customer of their assigned resource, along with some degree of explanation about the basis for that allocation. This may enhance consumer satisfaction as well as provide an opportunity for the customer to bring a problem with such assignment to the attention of the service provider and request and/or purchase a different assignment.

As noted above, a first component of a system for allocating semi-fungible resources relies upon tracking the available inventory. Historically, airlines that have provided customer-selected seating have presented an actual seat map to a customer and allowed the customer to select a particular seat, which leads to the various problems discussed above. Conversely, the system described herein relies upon a “virtual seat map” or more generally a virtual resource allocation, in which seats having various characteristics are tracked. Then, instead of (or in addition to) presenting the actual seat map to a customer, the customer can be presented with a list of choices for the type of seat he would prefer. Such preferences can include window/aisle/middle of the row, front/rear/middle of the aircraft, seats with increased legroom (bulkhead/exit row), seats with particular amenities (power ports, entertainment screens, audio ports, on-demand content, internet or other connectivity services, satellite services, telephones or other communications services, etc.), whether he wants to be adjacent a particular person or have an adjacent empty seat, and other characteristics such as being adjacent passenger services such as lavatories or food and beverage stations or entrance/exit points, or baggage storage space. As an alternative to presenting this information to the customer and receiving the expressed preference at the time of reservation, such information can be obtained from a customer database containing preferences or selections previously entered by the customer or otherwise derived from previous interactions or transactions with the customer.

Additionally, the options may be presented to the customer as either unconfirmed requests or confirmed guarantees. This can be advantageous for both the customer and the provider. Certain customers may be willing to pay extra charges for certain amenities, and a confirmed guarantee allows such customers to know with certainty that such an amenity will be available and also provides the service provider with a means of monetizing the resource. Conversely, other customers might prefer a certain option or characteristic, but be unwilling to pay extra for it. Such a customer would indicate a preference for such option, and, if capacity allows, a provider would meet such preference as a matter of customer satisfaction or service/operational recovery. However, if capacity did not allow, (i.e., if another customer were willing to pay a higher price for such preference or option), the provider would have the option of receiving the higher revenue from such customer.

An example of such an arrangement would be an airline passenger who is willing to pay extra for an aisle (or window) seat versus a passenger who would prefer an aisle (or window) seat, but is unwilling to pay any price beyond the basic fare for such a seat. The first passenger would purchase the confirmed guarantee, and the inventory tracking system would decrement the inventory of available aisle (or window) seats accordingly. The second passenger would indicate a preference for an aisle (or window) seat, but the inventory system would not decrement the inventory, thus providing subsequent passengers with the opportunity to purchase a confirmed guarantee. Additionally, the system could dynamically adapt to demand for certain features and thereby increase the price of options that are in higher demand. Thus, if a large number of passengers are selecting seats with available laptop computer power ports (as might happen on a New York or Chicago flight on a week day), the price may be increased as inventory of such seats decreases to attempt to better control demand to match capacity and maximize the carrier's revenue for such seats. Alternatively, if certain features are not in particularly high demand, the price to guarantee such options could be lowered, again attempting to maximize the carrier's revenue by allocating such features to customers who might be willing to pay a lesser amount for them.

In some embodiments, it might be desirable to provide the customer with some quantification of either the available inventory of a particular option or a projection of available inventory at some point in the future to inform the customer's decision as to whether to purchase a confirmed guarantee or rely upon a mere stated preference. For example, a customer who knows there are only three aisle seats remaining weeks before a flight may be more inclined to purchase a confirmed guarantee than a customer who knows that there are many such seats still available the day before a flight. Additionally, providing such quantification need not be a binary decision. Such quantification could be provided based on demand for a particular option or whenever less than some specified percentage of the option remains, etc.

In some instances, it may be desirable to allow a certain class of customers to select a confirmed guarantee without paying an extra charge. For example, an airline may allow frequent fliers of a certain status to guarantee certain options while requiring other passengers to purchase such options. Similarly, passengers having special requirements, such as families with small children, the elderly, handicapped passengers, etc. may be provided with accommodation in this regard, i.e., they may select a confirmed guarantee for no or reduced charge. Additionally, it may be desirable to allow certain passengers to bypass the virtual allocation and make a specific allocation directly. For example, an airline may allow frequent fliers and/or those who pay additional charges to directly select a seat without regard to the virtual seat allocation system described above.

Thus, throughout the reservation process, an inventory management system can track the available inventory of resources according to certain defining characteristics and can also track, both specifically and in the aggregate, customer preferences and/or guarantees regarding those characteristics. Then, at some point nearer the time the service is provided (e.g., just prior to check-in for an airline flight) the inventory and aggregate preference data can be combined to specifically assign the available inventory to each individual customer and, optionally, communicate that assignment to the customer, either prior to or at check-in.

As would be appreciated, resource assignments can be made by a system implementing various assignment algorithms. Such algorithms can take a variety of forms, but in general they must all have a set of rules that define an order of assignment (i.e., an assignment hierarchy). In the case of airline seat assignments, such a system might have three tiers. Thus, seats are first assigned in groups based on operational needs, guarantees, and preferences. Assignments based on operational needs might be based on factors such as federal regulation (e.g., which do not permit children in an exit row), or airline policies (e.g., which require unaccompanied minors to be seated in the front of the aircraft). Once all of the operationally required seats are assigned, seats can be assigned based on the guarantees which have either been provided to preferred customers or purchased by certain customers. Finally, once the guaranteed options have been allocated, assignments can be made based on preferences, accommodating such preferences to the extent possible based on the available inventory and the airline's willingness to honor those requests. For example, if the plane is booked to 50% of capacity, there is no compelling need to honor unconfirmed requests for extra legroom if doing so would crowd a business zone intended for customers paying a higher fare for a guarantee or customers having a higher status or score.

Within these various groups, the allocation system can allow customers to prioritize their requests by assigning a higher level of priority to various preferred features. For example, two passengers may each prefer an aisle seat and to be near the front of the aircraft. However, one might rather have a window seat near the front than be located at the rear while the other might prefer an aisle at the rear rather to be near the front of the aircraft. The allocation system can take such customer hierarchy of preferences into account when allocating the seats.

Within each group priority can be given based on some other hierarchy or status. One example would be assigning seats based on frequent flyer status, fare value, time of ticketing (e.g., first-come-first-served), or other customer scores. Customer scores can include a customer value score, which can take into account such factors as how frequently the customer travels, the aggregate value of those travels, etc. Thus, a passenger who is currently travelling on a discounted ticket, but is a frequent full-fare traveler might receive priority over other discount travelers. A customer mood score can be based on operational or service events such as problems recently experienced by that passenger. For example, a passenger who is taking a later flight because of overbooking or because airline delays caused him to miss an earlier flight might receive priority over a passenger who has not experienced such delays. Additionally, such customer scores might be based on the market, origin, and/or destination of the flight. For examples, flight to or from Orlando, Fla. (a popular family vacation destination) might give priority to seating families together, while flights to New York City (a popular business destination) might give priority to leaving adjacent seats empty to allow business travelers room to work.

Once the resources have been assigned, it may be desirable to notify the customers of the resource they have been assigned. In the airline context, this may be by providing a seat assignment at the time of check-in. Additionally or alternatively, a customer may be contacted directly by e-mail, SMS text messaging, Internet instant message, or the like. It may also be desirable in some instances to provide a customer with some level of explanation for why a particular assignment was made. For example, a passenger who had requested an aisle seat but receives a window or middle seat might be advised that the capacity of the flight did not allow him to receive the requested aisle seat. Alternatively, a passenger who has experienced delays during travel might receive an upgrade to first class with a note of apology for the inconvenience.

Additionally, if inventory permits, customers may be permitted to change their reservation and/or assigned resource at this point (i.e., check-in). These changes may be free of charge or an additional merchandised service. For example, on a flight where some aisle seats were assigned to passengers purchasing a confirmed guarantee and some aisle sets were allocated to passengers expressing a preference, a passenger who had expressed a preference for an aisle seat may choose to purchase a guaranteed aisle seat, thereby “bumping” another preference-expressing passenger who had a higher priority for that seat but has not yet checked-in for the flight. Another option would be to permit a passenger who is adjacent to an empty seat to purchase such seat at a reduced fare as an “extra seat” to ensure that the seat remains empty throughout the remainder of the booking and check-in process.

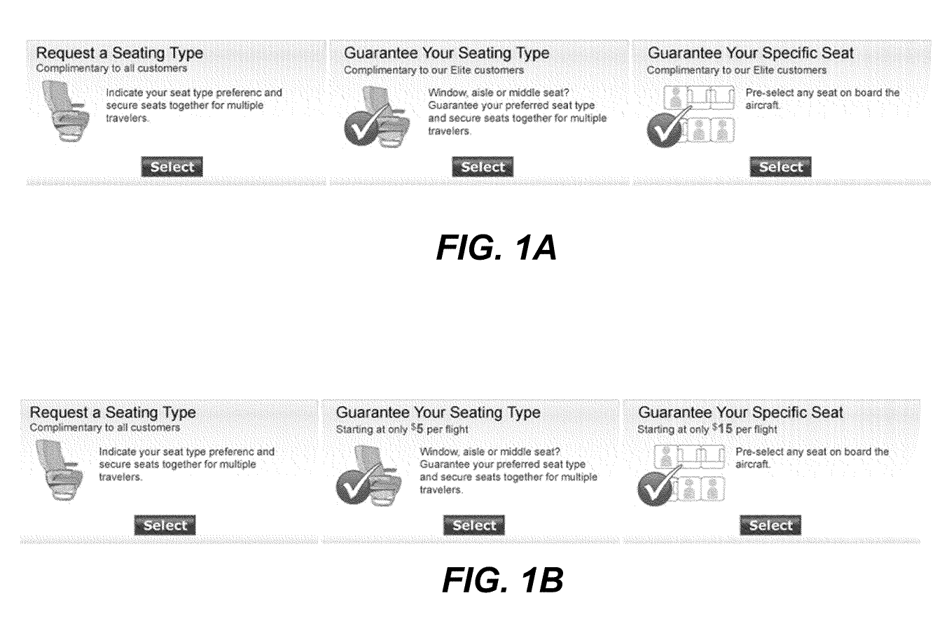

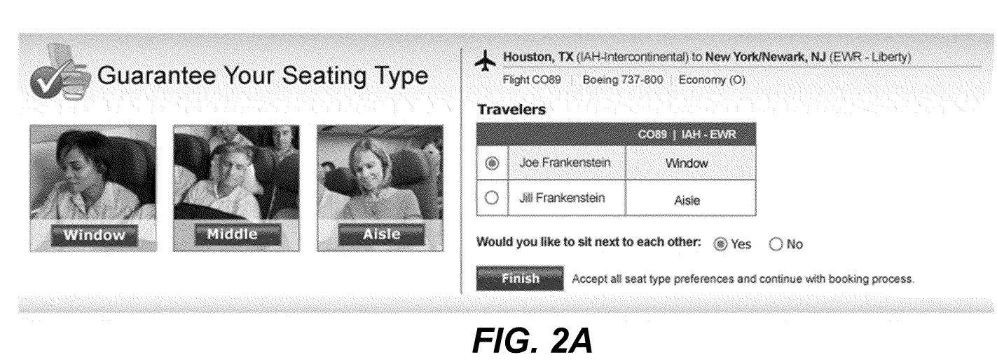

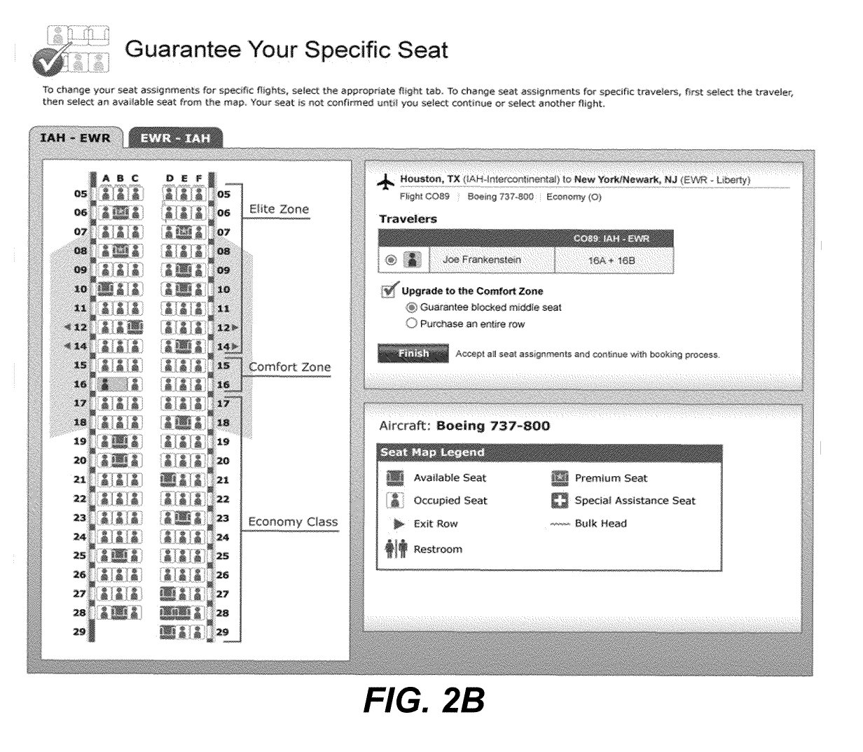

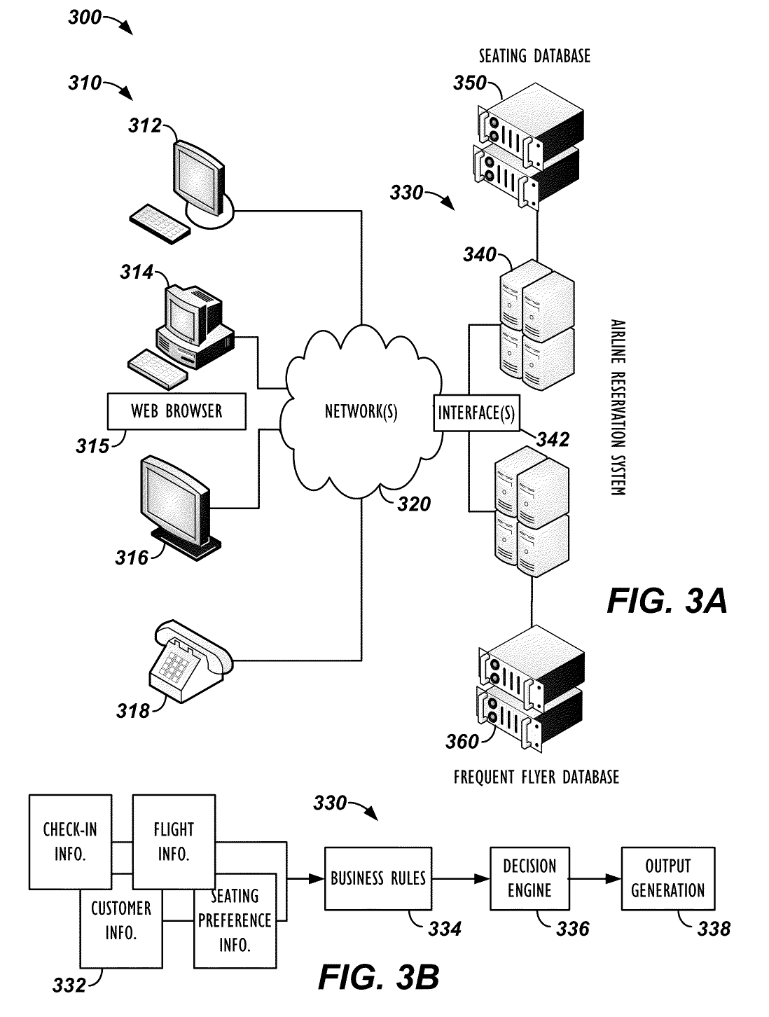

As will be appreciated, the techniques described above may preferably be implemented using programmed computer systems. For example, the inventory tracking and resource assignment algorithms may be implemented by a computerized reservation system. Such systems will be described with reference to the figures as set forth below. However, as an initial matter, such systems can present a user interface which can take a form of a web page including elements such as those generally illustrated in FIGS. 1A, 1B, 2A, and 2B. These arrangements are merely illustrative and can include more or less information. Moreover, more than one web page may be used to obtain this and other desired information from the passenger. Additionally, the details of the web page (or other interface) can be suited for any particular user interface for the particular type of terminal (See 310; FIG. 3) used to interact with the airline's reservation system.

FIG. 1A illustrates an initial seat assignment selection screen in which the seating preferences are offered to all users, while seat type guarantees or specific seat guarantees are offered to “Elite” members of a frequent flyer program. FIG. 1B illustrates an initial seat assignment selection screen in which seating preferences are offered to all customers, while a guaranteed seating type may be purchased for a fee starting at $5 and a guaranteed specific seat may be purchased for a fee starting at $15. FIG. 2A illustrates a screen that might be presented to a user who chooses to guarantee a particular seating type. The screen presents selections for a window, middle or aisle seat, and allows a passenger to indicate whether passengers travelling on the same reservation would like to be seated together. Additionally, the screen can provide identification of the flight, and an opportunity to make a selection final. Other information and/or choices may also be provided if appropriate to a given system. FIG. 2 B illustrates a screen that could be presented to a user who chose to guarantee a specific seat. Such a screen might provide a diagram of the aircraft indicating taken and available seats and identifying such seats as being located in a particular zone or cabin. Additionally, such a screen might provide an option to guarantee a blocked middle seat or purchase an entire row. As with the other user interface screens, other options may be presented depending upon the implementation of a particular system.

FIGS. 3A-3B show block diagrams of a computer system 300 for implementing the seat assignment techniques described above. Each element of the system 300 may represent a computer (i.e., a server, a special-purpose computer, a general-purpose computer with appropriate software programming, or a functional module within a general-purpose computer or server). Additionally, the various functional modules could be distributed across a number of computers. For their part, the computers will each include at least a processor, memory, and input and output devices and may include network interfaces, user interfaces, and printer interfaces.

Additionally, the methods described herein may be implemented using a non-transitory program storage device having program instructions stored thereon for causing a programmable control device to perform the automated passenger flight check-in methods. Accordingly, the methods described herein may be implemented using general-purpose computers and appropriate software, which may be stored on a non-transitory computer readable medium, including, for example, optical disks, magnetic disks or tapes, solid-state memory devices (ROM or RAM), etc.

As shown in FIG. 3A, a user (e.g., a passenger) can interact with an airline reservation system 330 via one or more types of terminal 310 and network 320. The terminal 310 can include a remote terminal 312, a personal computer 314, an automated kiosk 316, a telephone 318, a personal digital assistant (not shown), or other device. Likewise, the networks 320 can include the Internet, an intranet, a telephone network, or a network suited to the particular terminal 310.

For example, a passenger can interact with a ticket counter clerk, who may use the remote terminal 312 connected to the airline reservation system 330 via an appropriate network 320. Alternatively, the passenger can directly use a personal computer 314, an automated airport kiosk 316, a telephone 318 (either mobile or landline), or a personal digital assistant (not shown) to interact directly with the airline reservation system 330 via one or more applicable networks 320. In some embodiments, the terminal 310, such as the personal computer 314 or automated kiosk 316, may include an Internet web browser 315 or may include a special-purpose program for interacting with the airline reservation system 330. If the terminal 310 is a telephone 318, the airline reservation system 330 can use an interactive voice response (IVR) system (examples of which are known in the art) or a touch-tone dialing system (examples of which are also well known) to interact automatically with the passenger over the telephone 318 and appropriate network 320.

Using the terminal 310 and network 320, the user interacts with the airline reservation system 330. As shown, the airline reservation system 330 may include one or more computers (e.g., servers) 340 and one or more appropriate network interfaces 342. For example, the one or more servers 340 can include a web server or any another mechanism for interaction, such as IVR or touch-tone dialing as described above.

For its part, the airline reservation system 330 interacts with passenger seat preference data as described previously. In general, a user will indicate a seating preference at some point in time, and this preference will be indicated in the database. This user preference could be provided when purchasing the ticket (e.g., using the user terminal 310) or when signing up for a frequent flyer program. In the event a frequent flyer profile is used, the airline reservation system 330 may also interact with a frequent flyer database 360 in addition to the seating database 350. The databases 350/360 can be stored on one or more suitable storage devices, such as a database server or the like.

As shown in FIG. 3B, the reservation system 330 has various data sources 332 that can include customer, flight, check-in, seating preference, and other information. The customer info data source may include various identifying data about the customers. Seating preference info can include the identified preferences and confirmed guarantees described above. Flight info can include information about the specific equipment used for the flight (e.g., aircraft type and available seats of a given type). Check-in info may include a variety of other information relating to the check-in process, including those who have already checked-in and their assigned preferences or confirmed guarantees and/or those who have not yet checked-in and their assigned preferences/guarantees. These sources 332 can be incorporated into one or more databases. A decision engine 336 uses business rules 370 and make decisions about the information in the sources. For example, the rules 370 can be used to sort the seating assignment guarantees and preferences as described above. From the decision, the decision engine 336 leverages an output generation component 338, which generates the desired output (such as an e-mail, download, fax, etc. of a boarding pass, confirmation, or the like).

The foregoing description of preferred and other embodiments is not intended to limit or restrict the scope or applicability of the inventive concepts conceived of by the Applicants. For example, the techniques and devices have been described in the context of airline seat assignment procedures. However, the techniques and devices disclosed herein can be applied to other airline services, including, but not limited to, upgrades, meals or drinks, baggage allowance, in-flight entertainment choices, service items (e.g., pillows, blankets, etc.), access to the airline's lounge in the airport, and any other service offered by the airline or its partners. Additionally, the techniques and devices described in the context of airline travel herein may be equally applicable to reservations for services from other travel industries, including hotel reservations, automobile reservations, train reservations, restaurant reservations, etc.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A system for allocating semi-fungible resources among a plurality of customers, the system comprising one or more processors programmed to:
receive from one or more customers one or more requests for desired features associated with the semi-fungible resources, wherein the requests may be expressed as unconfirmed preferences or confirmed guarantees;
update an inventory of the semi-fungible resources based on the received requests without assigning a specific resource to a specific customer; and
adapt a presentation of options available to subsequent customers to reflect the updated inventory.

2. The system of claim 1 wherein the one or more processors is programmed to update an inventory of the semi-fungible resources by decrementing the available inventory of resources having a feature for which a request for a confirmed guarantee is received and not decrementing the available inventory of resources having a feature for which a request for an unconfirmed guarantee is received.

3. The system of claim 2 wherein the one or more processors are further programmed to allocate the semi-fungible resources among the plurality of customers at a predetermined time, wherein said allocation is based upon an aggregation of the received requests.

4. The system of claim 3 wherein said allocation is further based upon one or more rule sets.

5. The system of claim 2 wherein the one or more processors are programmed to adapt the presentation of options available to subsequent customers by altering the pricing of one or more options in response to the available inventory.

6. The system of claim 2 wherein the one or more processors are programmed to adapt the presentation of options available to subsequent customers by displaying an available inventory of the various options.

7. A method of allocating airplane seats to customers, the method comprising:
causing one or more programmed processors to present seat selection options to a customer;
receiving from the customer one or more requests for seat features, wherein the requests may be unconfirmed preferences or confirmed guarantees;
updating a seat inventory based on the received requests; and
adapting the presentation of seat selection options for subsequent customers to reflect the updated seat inventory.

8. The method of claim 7 wherein the seat selection options include position within the aircraft.

9. The method of claim 8 wherein position within the aircraft includes window or aisle seating.

10. The method of claim 8 wherein position within the aircraft includes front or rear of the aircraft.

11. The method of claim 8 wherein position within the aircraft includes one or more zones.

12. The method of claim 7 wherein the seat selection options include amenities associated with a seat.

13. The method of claim 12 wherein the amenities include one or more items selected from the group consisting of: in-flight entertainment, video screens, audio ports, on-demand content, Internet or connectivity services, satellite services, auxiliary power ports, phone or communications, additional leg room, additional elbow room, additional seat width, seat covering material, adjacent passenger services, adjacent entrance/exit points, baggage storage space/facilities, and empty adjacent seats.

14. The method of claim 7 wherein the seat selection options include adjacency to one or more other travellers.

15. The method of claim 7 wherein updating the seat inventory based on the received requests comprises decrementing the available inventory of seats having a feature for which a request for a confirmed guarantee is received and not decrementing the available inventory of resources having a feature for which a request for an unconfirmed guarantee is received.

16. The method of claim 7 wherein presenting seat selection options to a customer comprises allowing the customer to prioritize requests.

17. The method of claim 7 further comprising allocating the seats at a predetermined time prior to check-in, wherein said allocation is based upon an aggregation of the received requests.

18. The method of claim 17 wherein said allocation is further based upon one or more rule sets.

19. The method of claim 18 wherein said one or more rule sets include at least one rule set based upon operational requirements.

20. The method of claim 18 wherein said one or more rule sets include at least one rule set based upon customer hierarchy or status.

21. The method of claim 20 wherein said hierarchy or status comprises a customer value score.

22. The method of claim 20 wherein said customer hierarchy or status is a customer mood score based on one or more operational or service events.

23. The method of claim 7 wherein adapting the presentation of options available to subsequent customers comprises altering the pricing of one or more options in response to the available inventory.

24. The method of claim 7 wherein adapting the presentation of options available to subsequent customers comprises displaying an available inventory of the various options.

25. An airline seat assignment system comprising one or more processors programmed to:
present seat selection options to a customer, said options including at least one feature selected from the group consisting of position within an aircraft, amenities associated with the seat, and adjacency to one or more other passengers;
receive from the customer one or more prioritized requests for seat options, wherein the requests may be unconfirmed preferences or confirmed guarantees;
update a seat inventory based on the received requests by decrementing the available inventory of resources having a feature for which a request for a confirmed guarantee is received and not decrementing the available inventory of resources having a feature for which a request for an unconfirmed guarantee is received; and
adapt the presentation of seat selection options for subsequent customers to reflect the updated seat inventory.

26. The system of claim 25 wherein the one or more processors are further programmed to allocate the seats at a predetermined time prior to check-in, wherein said allocation is based upon an aggregation of the received requests and one or more rule sets.

27. The system of claim 26 wherein the one or more rule sets includes at least one rule set based on operational requirements and at least one rule set based on customer hierarchy or status.

28. The system of claim 25 wherein the one or more processors are programmed to adapt the presentation of options available to subsequent customers by altering the pricing of one or more options in response to the available inventory.

29. The system of claim 25 wherein the one or more processors are programmed to adapt the presentation of options available to subsequent customers by displaying an available inventory of the various options.
